(19) United States
(12) Patent Application Publication
(10) Pub. No.: US 2025/0045646 A1
(43) Pub. Date: Feb. 6, 2025

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventor: Yuta IGARASHI, Tokyo (JP)

(73) Assignee: NEC Corporation, Minato-ku, Tokyo (JP)

(21) Appl. No.: 18/716,531

(22) PCT Filed: Dec. 15, 2021
(86) PCT No.: PCT/JP2021/046268

§ 371 Date: Jun. 5, 2024

(51) Int. Cl. G06Q 10/02; G06Q 10/0631

(52) U.S. Cl. CPC G06Q 10/02; G06Q 10/06315

(57) ABSTRACT

In order to attain an object of providing, to a user, advice for more proper utilization of an AI platform, an information processing apparatus includes: an acquisition means (21) for acquiring log information of a target user and a resource usage ratio in an analysis environment in which analysis by machine learning is carried out; a generation means (22) for generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output means (23) for outputting the advice information which has been generated by the generation means.

### TECHNICAL FIELD

The present invention relates to an information processing apparatus, an information processing method, and a program which make it possible to provide, to a user, advice for more proper utilization of an AI platform.

### BACKGROUND ART

In recent years, while services and systems in which AI is incorporated have been actively developed in companies, a high amount of investment is often expected in order to construct an analysis model utilizing AI.

Under the circumstances, an AI platform is utilized. The AI platform provides an apparatus and software necessary for constructing analysis models. By utilizing the AI platform, burdens on users are greatly reduced.

In AI platform services, however, there are cases in which short-term and small-scale projects are frustrated. In such a case, a service user may cancel the service. Therefore, a technique is demanded which can provide, to a user, advice for more suitable utilization of an AI platform.

From the viewpoint of cancellation prediction, Patent Literature 1 proposes a technique in which a sales activity plan is generated using cancellation prediction so as to allow a sales representative to efficiently carry out a sales activity at an appropriate timing.

### CITATION LIST

### Patent Literature

[Patent Literature 1]
Japanese Patent Application Publication, No. 2021-64406

### SUMMARY OF INVENTION

### Technical Problem

With the AI platform, it is difficult to prevent cancellation unless progress of a project of the user is achieved. Therefore, even by using the technique of Patent Literature 1, it is difficult to generate suitable advice pertaining to the AI platform.

An example aspect of the present invention is accomplished in view of the above problem, and an example object thereof is to provide, to a user, advice for more suitable utilization of an AI platform.

### Solution to Problem

An information processing apparatus in accordance with an example aspect of the present invention includes: an acquisition means for acquiring log information of a target user and a resource usage ratio in an analysis environment in which analysis by machine learning is carried out; a generation means for generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output means for outputting the advice information which has been generated by the generation means.

An information processing method in accordance with an example aspect of the present invention includes: acquiring log information of a target user and a resource usage ratio in an analysis environment in which analysis by machine learning is carried out; generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and outputting the advice information which has been generated.

A program in accordance with an example aspect of the present invention causes a computer to function as an information processing apparatus which includes: an acquisition means for acquiring log information of a target user and a resource usage ratio in an analysis environment in which analysis by machine learning is carried out; a generation means for generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output means for outputting the advice information which has been generated by the generation means.

### Advantageous Effects of Invention

According to an example aspect of the present invention, it is possible to provide, to a user, advice for more suitable utilization of an AI platform.

### BRIEF DESCRIPTION OF DRAWINGS

FIG. 1 is a block diagram illustrating a configuration example of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration example of a cancellation prediction system in accordance with a second example embodiment of the present invention.

FIG. 4 is a block diagram illustrating a configuration example of a cancellation prediction apparatus.

FIG. 5 is a diagram for describing a prediction procedure of an advice information generation model 81.

FIG. 6 is a diagram for describing an example of advice information.

FIG. 7 is a flowchart for describing a flow of an advice information output process carried out by a cancellation prediction apparatus 10.

FIG. 8 is a block diagram illustrating a configuration example of a cancellation training-prediction apparatus 10A.

FIG. 9 is a flowchart for describing a flow of a training process carried out by the cancellation training-prediction apparatus 10A.

FIG. 10 is a block diagram illustrating a configuration example of the cancellation training-prediction apparatus 10A.

FIG. 11 is a diagram illustrating an example of a computer which executes instructions of a program for realizing functions.

### EXAMPLE EMBODIMENTS

### First Example Embodiment

The following description will discuss a first example embodiment of the present invention in detail, with reference to the drawings. The present example embodiment is a basic form of example embodiments described later.

### <Overview of Information Processing Apparatus 20>

An information processing apparatus 20 in accordance with the present example embodiment is, schematically speaking, an apparatus that generates information for an operator providing an AI platform to give advice to a user with use of operation monitoring data.

More specifically, for example, the information processing apparatus 20 includes: an acquisition means for acquiring log information of a target user and a resource usage ratio in an analysis environment in which analysis by machine learning is carried out; a generation means for generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output means for outputting the advice information which has been generated by the generation means.

### <Configuration of Information Processing Apparatus 20>

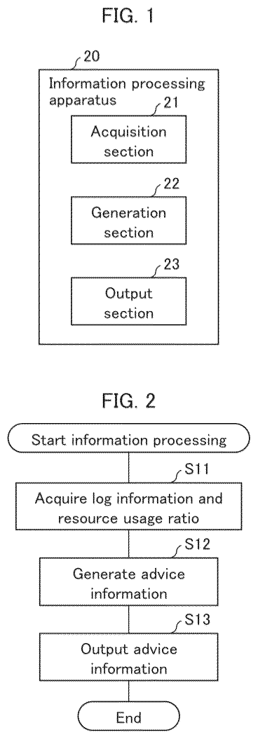

The following description will discuss a configuration of the information processing apparatus 20 in accordance with the present example embodiment, with reference to FIG. 1. FIG. 1 is a block diagram illustrating a configuration example of the information processing apparatus 20.

As illustrated in FIG. 1, the information processing apparatus 20 includes an acquisition section 21, a generation section 22, and an output section 23. The acquisition section 21 is configured to implement the acquisition means in the present example embodiment. The generation section 22 is configured to implement the generation means in the present example embodiment. The output section 23 is configured to implement the output means in the present example embodiment.

The acquisition section 21 acquires log information of a target user and a resource usage ratio in an analysis environment in which analysis by machine learning is carried out. Here, the analysis environment in which analysis by machine learning is carried out is, for example, an AI platform.

The log information includes, for example, an access history of a user, an execution history of analysis carried out on an AI platform, an error history, and the like.

The resource usage ratio is a usage ratio of, for example, a CPU, a memory, a GPU, or the like.

The generation section 22 generates advice information pertaining to the target user by inputting, into an advice information generation model, the log information of the target user and the resource usage ratio which have been acquired by the acquisition section 21, the advice information generation model having been trained to generate advice information from log information and a resource usage ratio in the analysis environment.

The advice information generation model is, for example, a prediction model which includes a decision tree type rule and a linear regression model. For example, log information of the target user and a resource usage ratio are classified by a conditional branch into cases based on the rule, and prediction is carried out for each of the cases by the linear regression model.

The advice information generation model is, for example, a model which has been trained by machine learning with reference to training data that includes a plurality of sets of (i) log information of a user and a resource usage ratio and (ii) advice information.

For example, as prediction by the linear regression model, a time when a user cancels an AI platform service is predicted. Moreover, by a conditional branch based on the rule, a factor by which the user cancels the AI platform service is predicted.

Then, advice information including advice for solving the cancellation factor is generated.

The output section 23 outputs the advice information generated by the generation section 22.

### <Flow of Information Processing Method by Information Processing Apparatus 20>

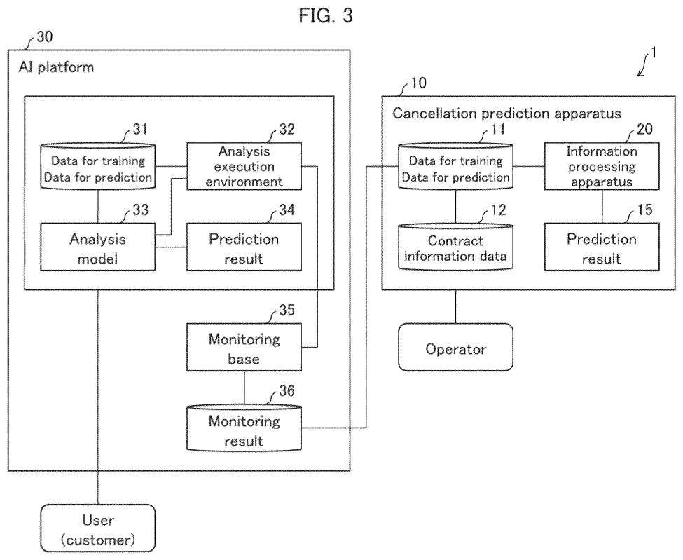

The following description will discuss a flow of an information processing method which is carried out by the information processing apparatus 20 configured as described above, with reference to FIG. 2. FIG. 2 is a flowchart illustrating the flow of the information processing method. As illustrated in FIG. 2, the information processing includes step S11, step S12, and step S13.

In step S11, the acquisition section 21 acquires log information of a target user and a resource usage ratio in an analysis environment in which analysis by machine learning is carried out.

In step S12, the generation section 22 generates advice information pertaining to the target user by inputting, into an advice information generation model, the log information of the target user and the resource usage ratio which have been acquired by the acquisition section 21, the advice information generation model having been trained to generate advice information from log information and a resource usage ratio in the analysis environment.

In step S13, the output section 23 outputs the advice information generated by the generation section 22.

### <Example Advantage of Information Processing Apparatus 20 and Information Processing Method>

According to the information processing apparatus 20 in accordance with the present example embodiment, log information of a target user and a resource usage ratio are acquired, and advice information pertaining to the target user is generated by inputting the log information of the target user and the resource usage ratio into an advice information generation model which has been trained to generate advice information from log information and a resource usage ratio in an analysis environment. With the configuration, it is possible to provide, to a user, advice for more suitable utilization of an AI platform. For example, it is possible to provide, to a user, advice for carrying out more accurate analysis, and it is thus possible to prevent a project from being frustrated.

### Second Example Embodiment

The following description will discuss a second example embodiment of the present invention in detail with reference to the drawings. The same reference numerals are given to constituent elements which have functions identical with those described in the first example embodiment, and descriptions as to such constituent elements are omitted as appropriate.

### <Configuration of Cancellation Prediction System 1>

The following description will discuss a configuration of a cancellation prediction system 1 in accordance with the present example embodiment, with reference to FIG. 3. FIG. 3 is a diagram for describing the cancellation prediction system. As illustrated in FIG. 3, the cancellation prediction system 1 includes a cancellation prediction apparatus 10 and an AI platform 30.

### (AI Platform 30)

The AI platform 30 provides an apparatus and/or software necessary for constructing an AI-based analysis model. The AI platform 30 can be used by, for example, a contract user.

A user who has concluded a contract with an operator acquires, for example, a user ID and a password, and is thus permitted to access the AI platform 30. Thus, the user constructs an analysis model using the AI platform. As such, the AI platform service is provided by the operator.

For example, the user is a data scientist and, in response to a request from a retail company, aims at constructing an analysis model for predicting sales of products as accurately as possible. In this case, pieces of information such as actual sales of products, customer attributes, and stores which were accumulated in the past are provided from the retail company, and a project for completing an analysis model within a time limit specified by the retail company is started.

The AI platform 30 includes a storage 31. The storage 31 stores data for training, data for prediction, and the like. The data for training is data including pieces of information such as, for example, actual sales of products, customer attributes, and stores which were accumulated in the past. The data for prediction is data including pieces of information such as, for example, a condition of sale of a product for which prediction is to be carried out.

The AI platform 30 further includes an analysis execution environment 32 and an analysis model 33. The analysis execution environment 32 is constituted by, for example, a computer or the like, and carries out arithmetic processing for analysis or the like. The analysis execution environment 32 may be implemented by, for example, cloud computing.

The analysis model 33 is generated by processing carried out in the analysis execution environment 32. The analysis model 33 is, for example, a prediction model which is constituted by model parameters stored in the storage 31.

A user inputs, into the analysis model 33, data pertaining to a condition of sale of a product for which prediction is to be carried out or the like, and thus obtains a prediction result 34.

The AI platform 30 further includes a monitoring base 35 and a storage 36. A user who uses the AI platform cannot access the monitoring base 35 and the storage 36, whereas the operator can access the monitoring base 35 and the storage 36.

The monitoring base 35 monitors processing carried out in the analysis execution environment 32. For example, the monitoring base 35 records, in the storage 36, a date and time at which the user logged into the analysis execution environment 32 and a date and time at which the user logged out from the analysis execution environment 32 as an access history to the AI platform 30. Moreover, the monitoring base 35 records, in the storage 36, a resource usage ratio of the analysis execution environment 32. The resource usage ratio is, for example, a CPU usage ratio and/or a memory usage ratio.

The monitoring base 35 records, in the storage 36, (i) a date and time of start and a date and time of end of a job pertaining to analysis which was carried out by the user in the analysis execution environment 32 and (ii) an error history indicating whether or not the job has been successfully completed.

The access history and the error information described above may be, for example, recorded in the storage 36 as log information. That is, the log information includes the number of times of access by the target user to the analysis execution environment, and an error history pertaining to the analysis.

The log information and the resource usage ratio as described above are stored in the storage 36 as a monitoring result. The monitoring result may include, in addition to the log information and the resource usage ratio, other pieces of information which have been acquired by the monitoring base 35. The monitoring result stored in the storage 36 is provided to the cancellation prediction apparatus 10 as data for training and data for prediction.

### (Cancellation Prediction Apparatus)

The cancellation prediction apparatus 10 is used by, for example, an operator that provides the AI platform 30. The cancellation prediction apparatus 10 predicts (i) a time when a user using the AI platform 30 cancels a contract for the AI platform service and (ii) a factor for the cancellation. In addition, the cancellation prediction apparatus 10 generates advice that should be provided from the operator to the user.

The cancellation prediction apparatus 10 includes a storage 11. The storage 11 stores data for training, data for prediction, and the like. The data for training is data including, for example, monitoring results accumulated in the past, and the like.

A storage 12 of the cancellation prediction apparatus 10 stores contract information data. For example, the contract information data is data including information indicating a date when a user started to use a service, a date when the user cancelled the service, and a reason why the user cancelled the service. The contract information data is stored as, for example, a database constituted by records for respective users. Note that, when a user cancels a contract for the AI platform service, the operator asks the user a reason for the cancellation and records contract information data including the reason for the cancellation.

The data for prediction is data including pieces of information such as, for example, a monitoring result pertaining to a user for whom prediction is to be carried out.

The information processing apparatus 20 predicts, using the advice information generation model, a cancellation time and a cancellation factor which are respectively a time when and a factor by which the user cancels the AI platform service. The information processing apparatus 20 generates advice information using the advice information generation model. The advice information generation model is constituted by model parameters which are obtained by machine learning carried out using data for training.

A prediction result 15 by the information processing apparatus 20 includes a cancellation time and a cancellation factor, and a remedial method for solving the cancellation factor. Based on the prediction result 15, advice information including a cancellation time and a cancellation factor is generated.

### <Configuration of Cancellation Prediction Apparatus 10>

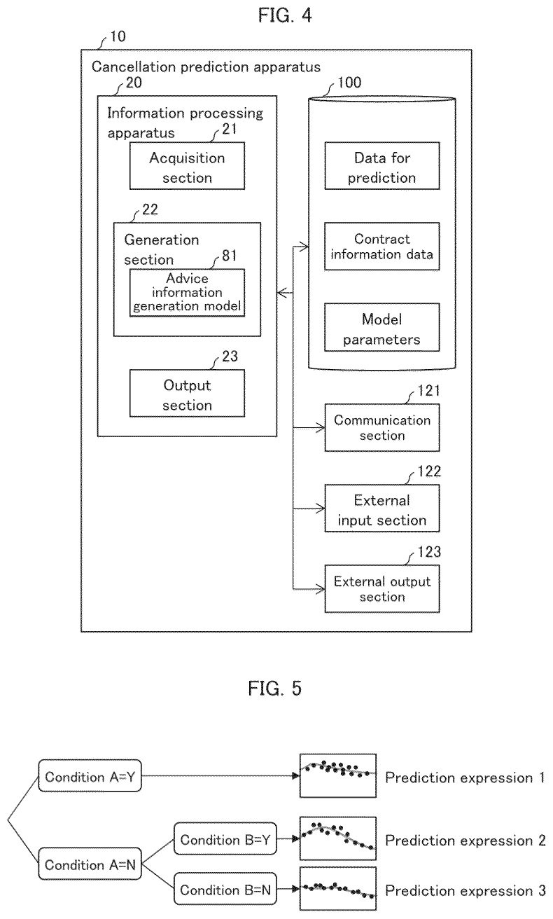

FIG. 4 is a block diagram illustrating a configuration example of the cancellation prediction apparatus 10. As illustrated in FIG. 4, the cancellation prediction apparatus 10 includes an information processing apparatus 20, a storage section 100, a communication section 121, an external input section 122, and an external output section 123.

The information processing apparatus 20 is a functional block which has functions similar to those of the information processing apparatus 20 described in the first example embodiment.

The storage section 100 is constituted by, for example, a semiconductor memory device or the like, and stores data. In this example, data for prediction and contract information data are stored in the storage section 100. The storage section 100 is a functional block corresponding to the storage 11 and the storage 12 illustrated in FIG. 3.

In the example of FIG. 4, data for prediction, contract information data, and model parameters are stored in the storage section 100. The model parameters are used for prediction by the advice information generation model 81.

The communication section 121 is an interface for connecting the cancellation prediction apparatus 10 to a network. A specific configuration of the network does not limited the present example embodiment but, as an example, it is possible to employ a wireless local area network (LAN), a wired LAN, a wide area network (WAN), a public network, a mobile data communication network, or a combination of these networks.

The external input section 122 receives various kinds of input to the cancellation prediction apparatus 10. A specific configuration of the external input section 122 does not limit the present example embodiment, and the external input section 122 may be, for example, configured to include an input device such as a keyboard, a touch pad, and the like. Alternatively, a configuration may be employed in which the external input section 122 includes a data scanner that reads data via electromagnetic waves such as infrared rays or radio waves, a sensor for sensing an environmental condition, and the like.

The external output section 123 is a functional block for outputting a processing result by the cancellation prediction apparatus 10. A specific configuration of the external output section 123 does not limit the present example embodiment. For example, the external output section 123 is constituted by a display, a speaker, a printer, or the like, and displays various processing results by the cancellation prediction apparatus 10 on a screen or outputs the various processing results as sounds or figures.

As described in the first example embodiment, the acquisition section 21 of the information processing apparatus 20 acquires log information of the target user and a resource usage ratio in the analysis execution environment 32. As described above with reference to FIG. 3, the log information and the resource usage ratio are stored in the storage 36 as a monitoring result and are used as data for prediction.

Note that the resource usage ratio cannot be acquired in units of users. Therefore, for example, a CPU usage ratio and/or a memory usage ratio in the analysis execution environment 32 within an execution time of a job specified from the log information is acquired.

The acquisition section 21 may further acquire contract information of the target user. For example, a time when the target user started using the service (i.e., a part of the contract information data stored in the storage section 100) may be acquired.

In the example of FIG. 4, the generation section 22 of the information processing apparatus 20 includes an advice information generation model 81.

The advice information generation model 81 classifies, by a conditional branch based on a rule, log information of the target user and a resource usage ratio which have been acquired by the acquisition section 21 into cases. In each of the cases, the advice information generation model 81 carries out prediction by a linear regression model. Note that the data input into the advice information generation model 81 may include contract information of the target user.

The output section 23 refers to the predicted cancellation factor and generates advice information including advice for solution.

### (Prediction by Advice Information Generation Model)

FIG. 5 is a diagram for describing a prediction procedure of the advice information generation model 81. For example, the advice information generation model is configured as a heterogeneous prediction model. The heterogeneous prediction model classifies input data by a conditional branch into cases according to a decision tree type rule, and carries out prediction with a linear model for which different explanatory variables are combined for each of the cases.

Here, the input data corresponds to data for prediction and contract information data. Examples of the input data include log information of the target user and a resource usage ratio, a time when the target user concluded a contract with respect to the AI platform service, and the like.

In the example of FIG. 5, input data is classified by a conditional branch into cases according to a condition A. In a case where the input data does not satisfy the condition A (condition A=N), the input data is further classified by a conditional branch into cases according to a condition B. As such, the input data is first classified by a conditional branch into cases according to the decision tree type rule.

In a case where the input data satisfies the condition A (condition A=Y), prediction by a prediction expression 1 is carried out. That is, a part of or a whole of information included in the input data is used as an explanatory variable, and prediction is carried out by arithmetic operation of a linear prediction expression for determining an objective variable.

In a case where the input data satisfies the condition B (condition B=Y), prediction by a prediction expression 2 is carried out. The prediction expression 2 may be, for example, a linear prediction expression which is different in weight variable from the prediction expression 1. Alternatively, the prediction expression 2 may be a linear prediction expression which is different in both weight variable and explanatory variable from the prediction expression 1. Alternatively, the prediction expression 2 may be a linear prediction expression for predicting an objective variable different from that by the prediction expression 1.

Furthermore, in a case where the input data satisfies the condition B (condition B=Y), prediction by a prediction expression 3 is carried out. The prediction expression 3 may be a linear prediction expression which is different in weight variable from the prediction expression 1 and the prediction expression 2, or may be a linear prediction expression which is different in both weight variable and explanatory variable from the prediction expression 1 and the prediction expression 2. Alternatively, the prediction expression 3 may be a linear prediction expression for predicting an objective variable different from those by the prediction expression 1 and the prediction expression 2.

As such, a linear model corresponding to each of the prediction expressions is selected by the rule of the decision tree, and prediction by the linear model is carried out.

For example, by prediction by linear models corresponding to the prediction expressions 1 through 3, a time when the user cancels the AI platform service is predicted. Moreover, by the conditional branch based on the rule of the decision tree, a factor by which the user cancels the AI platform service is predicted.

Alternatively, it is possible that a cancellation time is predicted by the conditional branch based on the rule of the decision tree, and a factor by which the user cancels the AI platform service is predicted by prediction by the linear models corresponding to the prediction expressions 1 through 3.

Alternatively, it is possible that linear models corresponding to the prediction expressions 1 through 3, which are selected through conditional branches based on a rule of one decision tree, are generated, and linear models corresponding to prediction expressions 4 through 6, which are selected through conditional branches based on a rule of another decision tree, are generated. Then, a cancellation time may be predicted by each of the linear models corresponding to the prediction expressions 1 through 3, and a cancellation factor may be predicted by each of the linear models corresponding to the prediction expressions 4 through 6.

In prediction analysis in the real world, it is demanded to explain the basis of prediction in an easy-to-understand manner. In complicated nonlinear prediction, even if prediction accuracy is high, behavior is made into a black box. In contrast, linear regression and decision trees are simple and easy to understand, but cannot capture behavior of complicated big data, resulting in low prediction accuracy.

As described above, by using the advice information generation model 81, which is a heterogeneous prediction model, it is possible to explain the basis of prediction in an easy-to-understand manner, and carry out prediction with high accuracy.

Next, the following description will discuss an example of the prediction result 15 by the cancellation prediction apparatus 10.

### Example 1 of Prediction Result

It is assumed that, for example, prediction is carried out by the advice information generation model 81 using data for prediction pertaining to a user U1, and a cancellation time is predicted to be within 1 month and a cancellation factor is predicted to be lack of knowledge about a method for using the AI platform.

In this case, it is confirmed, by a conditional branch according to a rule of the advice information generation model 81, that errors or stops of process during execution of the job by the user U1 frequently occur during the latest 14 days, and since then an access frequency has been reduced to 50% or less of that of before the occurrence. As a result of the conditional branch, the advice information generation model 81 predicts that a cancellation factor is lack of knowledge about a method for using the AI platform.

Moreover, a cancellation time is predicted by predicting arithmetic operation based on a linear prediction expression which has been selected as a result of the conditional branch.

The output section 23 refers to the predicted cancellation factor and refers to a start-up guide, and generates advice information including advice that setting items to be specified at the time of analysis should be reviewed. The advice is, for example, associated with a remedial method which is for solving the cancellation factor and is stored in advance in a table or the like. That is, the output section 23 selects, as advice to the target user, a remedial method which corresponds to the cancellation factor obtained as a prediction result by the advice information generation model 81.

### Example 2 of Prediction Result

It is assumed that, for example, prediction is carried out by the advice information generation model 81 using data for prediction pertaining to a user U2, and a cancellation time is predicted to be the end of fiscal year and a cancellation factor is predicted to be high cost due to inefficient use of a resource.

In this case, a time during which a job is carried out by the user U2 concentrates in a time period between 17:00 and 19:00 on weekdays, and a memory usage ratio exceeds 80%. Moreover, it is confirmed, by a conditional branch according to a rule of the advice information generation model 81, that, after passing through a high-load state for 2 to 3 hours, there is no operation log until 9:00 next morning.

The output section 23 refers to the predicted cancellation factor and generates advice information including advice that the cost should be reduced by scaling down the server.

### Example 3 of Prediction Result

It is assumed that, for example, prediction is carried out by the advice information generation model 81 using data for prediction pertaining to a user U3, and a cancellation time is predicted to be the end of fiscal year and a cancellation factor is predicted to be insufficient utilization of functions of the AI platform 30.

In this case, it is confirmed, by a conditional branch according to a rule of the advice information generation model 81, that an access frequency of the user U3 is on the decrease, and there is no log indicating use of a new function or engine of the AI platform 30 released a half year ago.

The output section 23 refers to the predicted cancellation factor and generates advice information including advice that the new function or engine should be tried.

### Example 4 of Prediction Result

For example, it is assumed that prediction is carried out by the advice information generation model 81 using data for prediction pertaining to a user U4, and a cancellation time is predicted to be within 1 month and a cancellation factor is predicted to be a failure of analysis due to insufficient data to be analyzed.

In this case, it is confirmed, by a conditional branch according to a rule of the advice information generation model 81, that a job execution time by the user U4 is short, the number of records of data is small, and there are many missing values of data used for variables.

The output section 23 refers to the predicted cancellation factor and generates advice information including advice that a sufficient number of valid data should be collected before analysis.

### Example 5 of Prediction Result

It is assumed that, for example, prediction is carried out by the advice information generation model 81 using data for prediction pertaining to a user U5, and a cancellation time is predicted to be the end of fiscal year and a cancellation factor is predicted to be dissatisfaction with cost-effectiveness.

In this case, it is confirmed, by a conditional branch according to a rule of the advice information generation model 81, that execution of a job by the user U5 is only once in a few months, and processing that takes approximately one day is carried out.

The output section 23 refers to the predicted cancellation factor and generates advice information including advice that a price plan suitable for an actual condition of analysis should be selected.

As such, the advice information generation model 81 is a model which generates advice information and carries out prediction of a cancellation factor and a cancellation time.

The advice information generation model 81 may be configured to include a first model which predicts a cancellation factor and a cancellation time from log information of the target user and a resource usage ratio, and a second model which generates advice information with reference to the cancellation factor and the cancellation time which have been predicted by the first model.

In this case, for example, the generation section 22 is provided with an advice information generation model 81-1 and an advice information generation model 81-2.

The advice information generation model 81-1, for example, predicts a cancellation factor and a cancellation time while using, as input, log information of the target user and a resource usage ratio which have been acquired by the acquisition section 21. The advice information generation model 81-2, for example, predicts advice information while using, as input, the cancellation factor and the cancellation time which have been predicted by the advice information generation model 81-1.

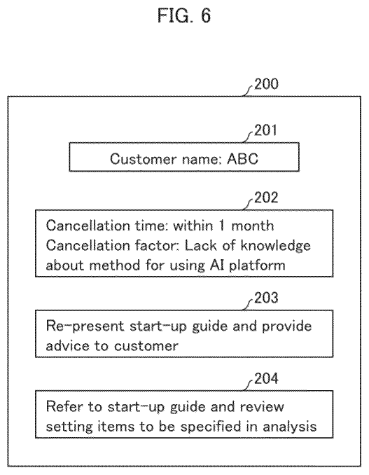

FIG. 6 is a diagram for describing an example of advice information. The advice information illustrated in FIG. 6 illustrates an example case in which the advice information is displayed on a display of a computer, a smart phone, or the like. The display can be a display that constitutes the external output section 123 of the cancellation prediction apparatus 10.

In the example of FIG. 6, a customer name display region 201 is displayed on a display 200. In this example, a customer name “ABC” is displayed. The display 200 also displays a cancellation time-cancellation factor display region 202. In this example, the cancellation time-cancellation factor display region 202 displays “Cancellation time: within 1 month” and “Cancellation factor: lack of knowledge about method for using AI platform”.

As such, the advice information includes prediction pertaining to a cancellation factor and a cancellation time.

Note that the display 200 may not display the cancellation time-cancellation factor display region 202.

Furthermore, an advice-for-operator display region 203 is displayed on the display 200. In this example, the advice-for-operator display region 203 displays “Re-present start-up guide and provide advice to customer”. The advice-for-operator display region 203 is a region in which advice to be presented from the standpoint of the operator to a user is displayed.

That is, the advice information includes advice to a provider that provides the analysis execution environment 32.

The display 200 also displays an advice-for-customer display region 204. In this example, the advice-for-customer display region 204 displays “Refer to start-up guide and review setting items to be specified in analysis”. The advice-for-customer display region 204 is a region in which advice that the user should directly refer to is displayed.

That is, the advice information includes advice to the target user.

Note that the advice information may not include the advice-for-customer display region 204. In this case, it is assumed that the advice information is displayed on, for example, a display constituting the external output section 123 of the cancellation prediction apparatus 10.

Alternatively, the advice information may not include the advice-for-operator display region 203. In this case, it is assumed that the advice information is displayed on, for example, a display of a smart phone of the user who is to be given advice.

### <Flow of Advice Information Output Process by Cancellation Prediction Apparatus 10>

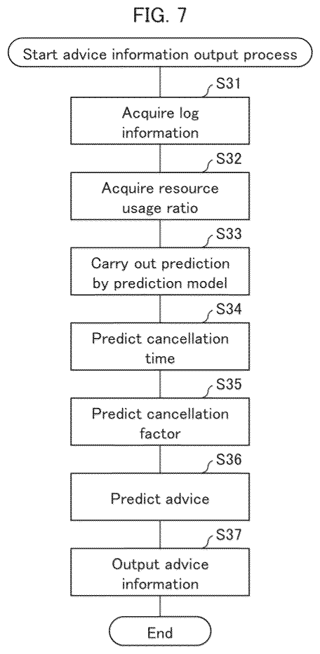

Next, the following description will discuss an example of an advice information output process carried out by the cancellation prediction apparatus 10, with reference to a flowchart of FIG. 7.

In step S31, the acquisition section 21 acquires log information.

The specific processing by the acquisition section 21 is as described above. At this time, for example, an access history and error information recorded in the storage 36 are acquired as log information. In step S31, contract information of the target user may be further acquired. For example, a time when the target user started using the service (i.e., a part of the contract information data stored in the storage section 100) may be acquired.

In step S32, the acquisition section 21 acquires a resource usage ratio. At this time, for example, as described above, a resource usage ratio of the analysis execution environment 32 recorded in the storage 36 is acquired.

In step S33, the generation section 22 carries out prediction by the advice information generation model 81. The specific processing by the generation section 22 is as described above. At this time, the log information acquired in step S31 and the resource usage ratio acquired in step S32 are input into the advice information generation model 81.

In step S34, the advice information generation model 81 predicts a cancellation time.

In step S35, the advice information generation model 81 predicts a cancellation factor.

In step S36, the advice information generation model 81 predicts advice.

The specific processing by the advice information generation model 81 is as described above. At this time, advice for an operator and/or advice for a customer is predicted by the advice information generation model. The advice for an operator is, for example, information displayed in the advice-for-operator display region 203 in FIG. 6. The advice for a customer is, for example, information displayed in the advice-for-customer display region 204 in FIG. 6.

In step S37, the output section 23 outputs advice information including the advice which has been predicted in step S36. The specific processing by the output section 23 is as described above. At this time, for example, advice information is presented on the screen as described above with reference to FIG. 6.

Note that the advice information may be output by being printed on a medium such as paper, or may be output as audio from a speaker or the like.

Thus, the advice information output process is carried out.

### Third Example Embodiment

The following description will discuss a third example embodiment of the present invention in detail, with reference to the drawings. The same reference numerals are given to constituent elements which have functions identical with those described in the first and second example embodiments, and descriptions as to such constituent elements are omitted as appropriate.

### <Configuration of Cancellation Training-Prediction Apparatus 10A>

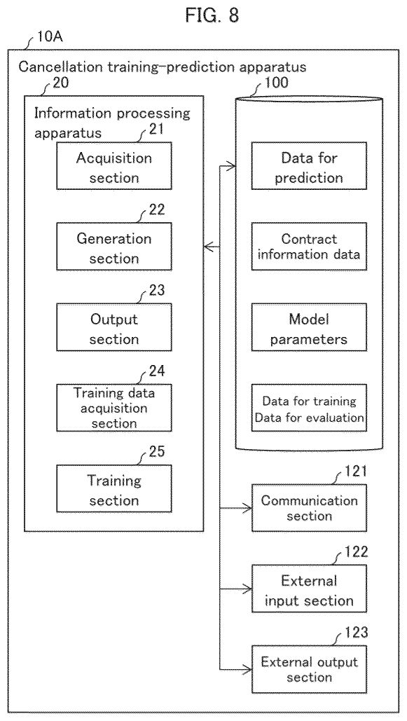

The following description will discuss a configuration of a cancellation training-prediction apparatus 10A in accordance with the present example embodiment, with reference to FIG. 8. The cancellation training-prediction apparatus 10A is an apparatus further having a function of training model parameters of the advice information generation model 81, in addition to the functions of the cancellation prediction apparatus 10.

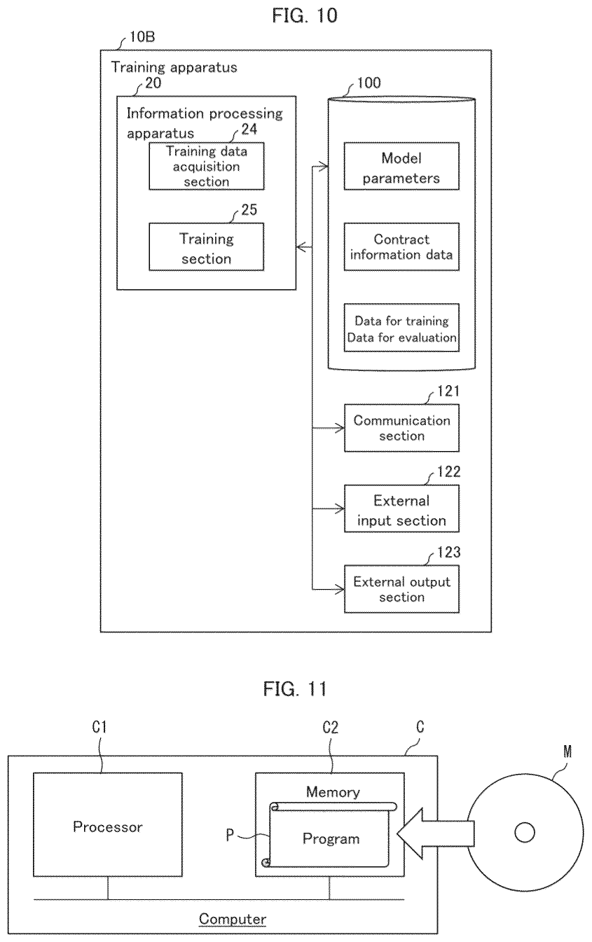

FIG. 8 is a block diagram illustrating a configuration example of the cancellation training-prediction apparatus 10A. The cancellation training-prediction apparatus 10A illustrated in FIG. 10 differs from the cancellation prediction apparatus 10 illustrated in FIG. 4 in the following points: the information processing apparatus 20 is provided with a training data acquisition section 24 and a training section 25, and the storage section 100 stores data for training and data for evaluation.

In the cancellation training-prediction apparatus 10A, data for training is stored in the storage section 100. As described above, the data for training is data including, for example, monitoring results accumulated in the past, and the like. More specifically, the data for training includes log information including the number of times of access by each of a plurality of users to the analysis execution environment, an execution history pertaining to the analysis, an error history, and the like. Note that the log information is stored for each of the users.

The data for training includes a resource usage ratio. Note that the resource usage ratio is, for example, a CPU usage ratio, a memory usage ratio, and/or a GPU usage ratio in the analysis execution environment 32 during an execution time of a job which has been executed by each of the users.

In the cancellation training-prediction apparatus 10A, the storage section 100 stores data for evaluation. The data for evaluation is data for verifying, for example, whether or not proper prediction can be carried out by the trained advice information generation model 81.

The training data acquisition section 24 acquires training data which is data used to train the advice information generation model 81. The training data is log information of each user, a resource usage ratio, and attribute information of each user.

In a case where a target user is a user who has already canceled the service, the attribute information is, for example, a date when the target user started using the service, a cancellation date of the target user, a cancellation reason of the target user, and a cancellation prevention measure to be presented to the target user.

The date when the target user started using the service, the cancellation date of the target user, and the cancellation reason of the target user are included in, for example, the contract information data. The cancellation prevention measure to be presented to the target user is, for example, a cancellation prevention measure that the operator considers should have been presented in order to prevent the user from canceling the service. The cancellation prevention measure corresponds to, for example, advice for an operator displayed in the advice-for-operator display region 203 of FIG. 6 and/or advice for a customer displayed in the advice-for-customer display region 204.

The cancellation prevention measure to be presented to the target user is input by the operator via, for example, the external input section 122 and is stored as a part of the contract information data.

The training data acquisition section 24 acquires, for each user in order to train the advice information generation model 81, a set of (i) a use-of-service start date, log information, and a resource usage ratio and (ii) a cancellation date, a cancellation reason, and a cancellation prevention measure. Note that the use-of-service start date may not be acquired. That is, the training data acquisition section 24 acquires training data which includes a plurality of sets of (i) log information and a resource usage ratio in the analysis execution environment 32 and (ii) advice information.

Note that the training data may be acquired by the acquisition section 21. In this case, the training data acquisition section 24 may not be provided in the cancellation training-prediction apparatus 10A.

The training section 25 trains the advice information generation model 81 by carrying out machine learning with reference to training data acquired by the training data acquisition section 24 or by the acquisition section 21. More specifically, the training section 25 trains the advice information generation model 81 by updating model parameters of the advice information generation model 81 with reference to training data.

As described above, the advice information generation model 81 may be configured to include a first model which predicts a cancellation factor and a cancellation time, and a second model which generates advice information with reference to the cancellation factor and the cancellation time which have been predicted by the first model. In this case, the training data acquisition section 24 or the acquisition section 21 acquires training data which includes a plurality of sets of (i) log information and a resource usage ratio in the analysis environment and (ii) a cancellation factor and a cancellation time, and the training section 25 trains a first model included in the advice information generation model with use of the training data.

### <Flow of Training Process Carried Out by Cancellation Training-Prediction Apparatus 10A>

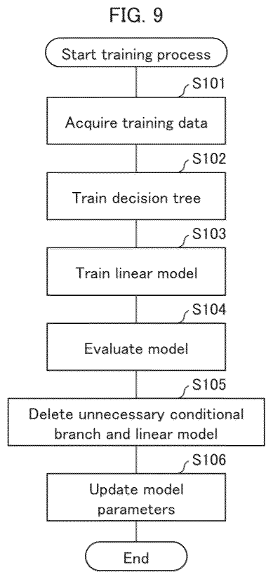

Next, the following description will discuss a training process carried out by the cancellation training-prediction apparatus 10A, with reference to a flowchart of FIG. 9.

In step S101, the training data acquisition section 24 acquires training data. The specific processing by the training data acquisition section 24 is as described above. At this time, a set of (i) a use-of-service start date, log information, and a resource usage ratio and (ii) a cancellation date, a cancellation reason, and a cancellation prevention measure is acquired for each user. Note that the use-of-service start date may not be acquired.

In step S102, the training section 25 trains a decision tree of the advice information generation model 81. Thus, an appropriate threshold value is learned for variables obtained from the log information and the resource usage ratio.

Examples of variables obtained from log information and a resource usage ratio are as follows.
(1) The number of times of access to the analysis execution environment: The number of times during the latest 30 days, the number of times during the latest 7 days, and a difference therebetween
(2) Presence or absence of error during analysis execution: Presence or absence during the latest 28, 21, 14, and 7 days, and differences therebetween
(3) The number of stops of the process: The number of stops during the latest 28, 21, 14, and 7 days, and differences therebetween
(4) A fact that the CPU usage ratio has exceeded a specified threshold value: A time zone, a time of exceeding, and the number of times of exceeding during a day
(5) A fact that the memory usage ratio has exceeded a specified threshold value: A time zone, a time of exceeding, and the number of times of exceeding during a day
(6) Quantity/quality of data for training in preparation of an analysis model: The number of records and a type of data

In step S102, for example, a threshold value is learned which is optimal for a case where conditional branches are carried out by a decision tree with use of the variables indicated in (1) through (6) above.

In step S103, the training section 25 trains a linear model of the advice information generation model 81. Thus, an appropriate weight coefficient is learned for variables obtained from the log information and the resource usage ratio. As variables obtained from the log information and the resource usage ratio used at this time, for example, a combination of different variables is selected in accordance with each result of conditional branches by the decision tree. That is, as described above with reference to FIG. 5, different linear models are selected in accordance with results of conditional branches by the decision tree. Therefore, a combination of different variables is selected in accordance with each of the linear models.

In step S104, the training section 25 evaluates the advice information generation model 81 which has been trained through the processes in step S102 and step S103. At this time, evaluation is carried out using the data for evaluation.

In step S105, the training section 25 deletes, with reference to the evaluation result in step S104, an unnecessary conditional branch in the decision tree and a linear model which is selected as a result of that conditional branch.

In step S106, the training section 25 updates the model parameters of the advice information generation model 81 while reflecting the result of the process in step S105.

Thus, the training process is carried out.

### Fourth Example Embodiment

The following description will discuss a fourth example embodiment of the present invention in detail with reference to the drawings. The same reference numerals are given to constituent elements which have functions identical with those described in the first through third example embodiments, and descriptions as to such constituent elements are omitted as appropriate.

### <Configuration of Training Apparatus 10B>

The following description will discuss a configuration of a training apparatus 10B in accordance with the present example embodiment, with reference to FIG. 10.

Unlike the cancellation training-prediction apparatus 10A described above with reference to FIG. 10, the training apparatus 10B is an apparatus which is configured as follows: that is, the training apparatus 10B does not have a function related to generation of advice information, but has a function related to training of model parameters. That is, the training apparatus 10B is not provided with the acquisition section 21, the generation section 22, and the output section 23 in the information processing apparatus 20. The other configurations of the training apparatus 10B are similar to those of the cancellation training-prediction apparatus 10A, and detailed descriptions thereof will be omitted.

The training apparatus 10B executes the training process described with reference to FIG. 9, and trains model parameters in the storage section 100. After training has been carried out with reference to a sufficient number of sets of training data, model parameters stored in the storage section 100 of the training apparatus 10B are stored, for example, in a storage medium such as a USB memory. Then, the model parameters stored in the storage medium are used by another apparatus (e.g., the cancellation prediction apparatus 10 in FIG. 3). Alternatively, the model parameters of the training apparatus 10B may be transferred to another apparatus via a network.

With the configuration, for example, model parameters obtained by training with reference to different pieces of training data can be provided to other apparatuses.

### Software Implementation Example

Some or all of the functions of each of the information processing apparatus 20, the cancellation prediction apparatus 10, the cancellation training-prediction apparatus 10A, and the training apparatus 10B may be implemented by hardware such as an integrated circuit (IC chip), or may be implemented by software.

In the latter case, each of the information processing apparatus 20, the cancellation prediction apparatus 10, the cancellation training-prediction apparatus 10A, and the training apparatus 10B is realized by, for example, a computer that executes instructions of a program that is software realizing the foregoing functions. FIG. 11 illustrates an example of such a computer (hereinafter, referred to as “computer C”).

The computer C includes at least one processor C1 and at least one memory C2. The memory C2 stores a program P for causing the computer C to function as the information processing apparatus 20, the cancellation prediction apparatus 10, the cancellation training-prediction apparatus 10A, or the training apparatus 10B. The processor C1 of the computer C retrieves the program P from the memory C2 and executes the program P, so that the functions of the information processing apparatus 20, the cancellation prediction apparatus 10, the cancellation training-prediction apparatus 10A, or the training apparatus 10B are implemented.

Examples of the processor C1 include a central processing unit (CPU), a graphic processing unit (GPU), a digital signal processor (DSP), a micro processing unit (MPU), a floating point number processing unit (FPU), a physics processing unit (PPU), a microcontroller, and a combination thereof. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary note 1

An information processing apparatus, including: an acquisition means for acquiring log information of a target user and a resource usage ratio in an analysis environment in which analysis by machine learning is carried out; a generation means for generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output means for outputting the advice information which has been generated by the generation means.

### Supplementary Note 2

The information processing apparatus according to supplementary note 1, in which: the log information includes the number of times of access by the target user to the analysis environment, and an error history pertaining to the analysis.

### Supplementary Note 3

The information processing apparatus according to supplementary note 1 or 2, in which: the advice information includes prediction pertaining to a cancellation factor and a cancellation time.

### Supplementary Note 4

The information processing apparatus according to supplementary note 3, in which: the advice information generation model includes a first model which predicts a cancellation factor and a cancellation time from log information of the target user and a resource usage ratio, and a second model which generates advice information with reference to the cancellation factor and the cancellation time which have been predicted by the first model.

### Supplementary Note 5

The information processing apparatus according to any one of supplementary notes 1 through 4, in which: the advice information includes advice to a provider that provides the analysis environment.

### Supplementary Note 6

The information processing apparatus according to any one of supplementary notes 1 through 5, wherein: the advice information includes advice to the target user.

### Supplementary Note 7

The information processing apparatus according to any one of supplementary notes 1 through 6, further including: a training section for training the advice information generation model.

### Supplementary Note 8

The information processing apparatus according to supplementary note 7, in which: the acquisition means acquires training data which includes a plurality of sets of (i) log information and a resource usage ratio in the analysis environment and (ii) advice information; and the training section trains the advice information generation model with use of the training data.

### Supplementary Note 9

The information processing apparatus according to supplementary note 8, in which: the acquisition means acquires training data which includes a plurality of sets of (i) log information and a resource usage ratio in the analysis environment and (ii) a cancellation factor and a cancellation time; and the training section trains a first model included in the advice information generation model with use of the training data.

### Supplementary Note 10

An information processing method, including: acquiring log information of a target user and a resource usage ratio in an analysis environment in which analysis by machine learning is carried out; generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and outputting the advice information which has been generated.

### Supplementary Note 11

A program for causing a computer to function as an information processing apparatus which includes: an acquisition means for acquiring log information of a target user and a resource usage ratio in an analysis environment in which analysis by machine learning is carried out; a generation means for generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output means for outputting the advice information which has been generated by the generation means.

### Additional Remark 3

Furthermore, some of or all of the foregoing example embodiments can also be expressed as below.

Provided is at least one processor which carries out: an acquisition process of acquiring log information of a target user and a resource usage ratio in an analysis environment in which analysis by machine learning is carried out; a generation process of generating advice information pertaining to the target user by inputting, into an advice information generation model, the log information of the target user and the resource usage ratio which have been acquired by the acquisition means, the advice information generation model having been trained to generate advice information from log information and a resource usage ratio in the analysis environment; and an output process of outputting the advice information which has been generated by the generation means.

Note that the information processing apparatus can further include a memory. The memory can store a program for causing the at least one processor to carry out the acquisition process and the output sequence generation process. The program can be stored in a computer-readable non-transitory tangible storage medium.

### REFERENCE SIGNS LIST

1: Cancellation prediction system
10: Cancellation prediction apparatus
10A: Cancellation training-prediction apparatus
10B: Training apparatus
20: Information processing apparatus
21: Acquisition section
22: Generation section
23: Output section
24: Training data acquisition section
25: Training section
30: AI platform
32: Analysis execution environment
35: Monitoring base
81: Advice information generation model
100: Storage section
121: Communication section
122: External input section
123: External output section

What is claimed is:

1. An information processing apparatus, comprising at least one processor, the at least one processor carrying out:
an acquisition process of acquiring log information of a target user and a resource usage ratio in an analysis environment in which analysis by machine learning is carried out;
a generation process of generating advice information pertaining to the target user by inputting, into an advice information generation model, the log information of the target user and the resource usage ratio which have been acquired in the acquisition process, the advice information generation model having been trained to generate advice information from log information and a resource usage ratio in the analysis environment; and
an output process of outputting the advice information which has been generated in the generation process.

2. The information processing apparatus according to claim 1, wherein:
the log information includes the number of times of access by the target user to the analysis environment, and an error history pertaining to the analysis.

3. The information processing apparatus according to claim 1, wherein:
the advice information includes prediction pertaining to a cancellation factor and a cancellation time.

4. The information processing apparatus according to claim 3, wherein:
the advice information generation model includes
a first model which predicts a cancellation factor and a cancellation time from log information of the target user and a resource usage ratio, and
a second model which generates advice information with reference to the cancellation factor and the cancellation time which have been predicted by the first model.

5. The information processing apparatus according to claim 1, wherein:
the advice information includes advice to a provider that provides the analysis environment.

6. The information processing apparatus according to claim 1, wherein:
the advice information includes advice to the target user.

7. The information processing apparatus according to claim 1, wherein the at least one processor further carries out:
a training process of training the advice information generation model.

8. The information processing apparatus according to claim 7, wherein:
in the acquisition process, the at least one processor acquires training data which includes a plurality of sets of (i) log information and a resource usage ratio in the analysis environment and (ii) advice information; and
in the training process, the at least one processor trains the advice information generation model with use of the training data.

9. The information processing apparatus according to claim 8, wherein:
in the acquisition process, the at least one processor acquires training data which includes a plurality of sets of (i) log information and a resource usage ratio in the analysis environment and (ii) a cancellation factor and a cancellation time; and
in the training process, the at least one processor trains a first model included in the advice information generation model with use of the training data.

10. An information processing method, comprising:
acquiring log information of a target user and a resource usage ratio in an analysis environment in which analysis by machine learning is carried out;
generating advice information pertaining to the target user by inputting, into an advice information generation model, the log information of the target user and the resource usage ratio which have been acquired, the advice information generation model having been trained to generate advice information from log information and a resource usage ratio in the analysis environment; and
outputting the advice information which has been generated.

11. A non-transitory storage medium storing a program for causing a computer to carry out:
an acquisition process of acquiring log information of a target user and a resource usage ratio in an analysis environment in which analysis by machine learning is carried out;
a generation process of generating advice information pertaining to the target user by inputting, into an advice information generation model, the log information of the target user and the resource usage ratio which have been acquired in the acquisition process, the advice information generation model having been trained to generate advice information from log information and a resource usage ratio in the analysis environment; and
an output process of outputting the advice information which has been generated in the generation process.
